(19) United States
(12) Patent Application Publication
(10) Pub. No.: US 2024/0237666 A1
(43) Pub. Date: Jul. 18, 2024

(54) Salted spreadable food cream, as well as semi-finished product and method for preparing thereof

(71) Applicants: Alessandro Longhin, Atessa (IT); Giuseppe De Marcellis, Teramo (IT)

(72) Inventors: Alessandro Longhin, Atessa (IT); Giuseppe De Marcellis, Teramo (IT)

(21) Appl. No.: 18/554,269

(22) PCT Filed: Apr. 7, 2022
(86) PCT No.: PCT/IB2022/053255

§ 371 Date: Oct. 6, 2023

(30) Foreign Application Priority Data
Apr. 7, 2021 (IT) 102021000008693

(51) Int. Cl. A23D 7/005; A23C 23/00; A23D 7/01; A23L 27/20; A23L 27/26; A23L 27/27

(52) U.S. Cl. CPC A23D 7/0056; A23C 23/00; A23D 7/013; A23L 27/206; A23L 27/26; A23L 27/27

(57) ABSTRACT

A salted spreadable food cream consists from 3%-60% by weight of a lipid component (A) including or consisting of a solid fat; (B) 5%-50% by weight of a dehydrated, dried, and/or freeze-dried flavor component; (C) 5%-70% by weight of a filler consisting of milk or its derivatives; (D) 0.2%-3% by weight of an emulsifier; and (E) 0%-5% by weight of a supporting ingredient, has salt between 1 g/100 g and 2.5 g/100 g, a viscosity between 11,000 cP and 65,000 cP, a fineness between 10 pm and 100 pm, and a water activity value lower than 0.5. A method for the preparation of the salted spreadable food cream includes providing the ingredients (A) to (D) and optionally (E), and refining the ingredients (A)-(D) and optionally (E) at a predetermined working temperature for a predetermined working time.

### FIELD OF THE INVENTION

The present invention generally relates to the technical field of food technology, and it particularly has as object a spreadable food cream, as well as a method for preparing thereof.

Another object of the present invention is a semi-finished product for preparing thereof.

### Definitions

In the present text, the phrase “% by weight” and its derivatives referred to one or more ingredients of the salted spreadable food cream indicates the weight percentage of such one or more ingredients with respect to the total weight of the salted spreadable cream.

In the present text, the phrase “substantially free of” and its derivatives referred to one or more ingredients of the spreadable cream indicates that the percentage by weight of said one or more ingredients is less than or equal to 1% with respect to the total weight of the spreadable cream.

In the present text, the phrase “solid fat” and its derivatives refers to a fat in solid form at ambient temperature and pressure.

In the present text, the term “salted or mainly salted” and its derivatives refers to the organoleptic aspect attributable to the taste perceived by the consumer.

In the present text, the term “residual humidity” and its derivatives indicates the percentage of the remaining humidity after a drying or dehydration process of a specific food or ingredient.

In the present text, the term “water activity” and its derivatives indicates the water availability in a certain ingredient or food, expressed in a dimensionless value ranging from 0 to 1 defining the ratio between the water steam pressure in the same ingredient or food and the steam pressure of pure water.

In the present text, the term “supporting ingredient” and its derivatives indicates an optional ingredient suitable to improve the organoleptic, nutritional and/or structural performance of the salted spreadable food cream that is the object of the present invention.

In the present text, the term “providing” or its derivatives indicates the preparation of one or more ingredients of interest for a step of a process of interest, therefore including any prior treatment suitable to the optimal completion of the same step of interest, starting from the simple collection and potential storing to thermal and/or chemical and/or physical pretreatments and similar.

In the present text, the phrase “added sugars” or its derivatives refers to sugars and syrups added to food during treatment or during industrial preparation. They are therefore not fruit sugars or sugars found in vegetables or milk.

In the present text, the term “sweeteners” or its derivatives refers to sweetening products substitute for simple sugar (sucrose), honey or fructose. These products are used because they contain few or zero calories, therefore in most cases, they have no nutritional power, they do not provide energy, and yet have a certain impact on metabolism and insulin production. There are artificial or synthetic sweeteners (which are the most common and used by both the food industry and private consumers) and “natural” sweeteners.

### Background of the Invention

Salted spreadable food creams, generally pasteurized, such as cheese creams, pates and sauces are well known.

Typically, the pasteurization process may affect the flavor of raw materials, as well as their nutritional characteristics.

Once opened, such creams must be consumed in a few days, otherwise they will deteriorate.

It is evident that such a low durability is incompatible with an industrial product which instead requires a relatively long shelf life and durability once opened.

### SUMMARY OF THE INVENTION

Object of the present invention is to overcome, at least partially, the drawbacks illustrated above, by providing a salted spreadable food cream susceptible to consumption at ambient temperature.

Another object of the present invention is to provide a salted spreadable food cream having a relatively long shelf life.

Another object of the present invention is to provide a salted spreadable food cream storable at ambient temperature.

Another object of the present invention is to provide a salted spreadable food cream storable at ambient temperature for a relatively long period of time once the package containing it has been opened.

Another object of the present invention is to provide a salted spreadable food cream that maintains its characteristics practically unaltered once its package has been opened.

Such objects, as well as others that will be clearer hereinafter, are fulfilled by a salted spreadable food cream and/or by a method and/or by a semi-finished product for preparing thereof in accordance with what is herein described, shown and/or claimed.

The salted spreadable food cream in accordance with the present invention may be consisting of:
A) 3% by weight to 60% by weight of at least one lipid component;
B) 5% by weight to 50% by weight of at least one dehydrated and/or dried and/or freeze-dried flavour component;
C) 5% by weight to 70% by weight of at least one filler consisting of milk or its derivatives;
D) 0.2% by weight to 3% by weight of at least one emulsifier;
E) 0% by weight (that is to say not present) to 5% by weight of at least one further supporting ingredient;
wherein the % by weight are related to the total weight of the food cream and the sum of the components from A) to E) is the 100% of the food cream.

In particular, the lipid component (A) may be of a quantity between 3% by weight and 60% by weight, more preferably between 20% and 50%, even more preferably between 30% and 40%.

In general, the salted spreadable cream may have a viscosity between 11,000 cP and 65,000 cP, and it may for example be measured by a Brookfield viscometer in a per se known way. Optionally, the viscosity measurement may be made in accordance with the ISO 2555:2018 standard regulations.

Preferably, the viscosity may be between 20,000 cP and 55,000 cP, and even more preferably between 28,000 cP and 45,000 cP, giving the cream the characteristic of spreadability.

Preferably, the lipid component (A) may be consisting of at least one solid fat and at least one oil. It is understood that “solid fat” means solid fat substances at ambient temperature and pressure.

For example, the solid fat may be selected from the group consisting of: cocoa butter, palm butter, coconut fat, cow butter, karite butter, illipe butter, or a mixture of two or more of these. On the other hand, the oil may be selected from the group consisting of: sunflower oil, olive oil, extra virgin olive oil, rapeseed oil, rice oil, corn oil, linseed oil, sesame seed oil, peanut oil, or a mixture of two or more of these.

In such case, in the lipid component the liquid part may be in a greater quantity than the solid one.

Suitably, therefore, in the lipid component (A) the weight ratio between the one or more oils and the one or more solid fats is between 60:40 and 90:10, preferably between 65:35 and 85:15 and even more preferably between 70:30 and 80:20.

In such case, the cream includes a relatively high quantity of fats and a relatively low protein intake. In such spreadable cream, generally, per 100 g of product the proteins may be less than or equal to 25 g, and preferably less than or equal to 20 g.

On the other hand, in a preferred but not exclusive version of the invention, the spreadable cream may be used for nutrition in the sport field, dietetic field or otherwise in those areas that require a controlled nutrition.

In this case, the protein intake may be relatively high, for example greater than 25 g, and preferably greater than or equal to 30 g per 100 g of product.

In order to ensure this high intake, the filler (C) may include at least one high protein ingredient, such as whey protein powder, milk protein powder, concentrated milk protein powder or a mixture of two or more of these.

Preferably, the at least one high protein ingredient may be present in a quantity that is greater than or equal to 20% by weight with respect to the total weight of the food cream, preferably in a quantity that is greater than or equal to 22% by weight with respect to the total weight of the food cream, and even more preferably in a quantity that is greater than or equal to 25% by weight with respect to the total weight of the food cream.

In this case, moreover, in the lipid component (A) the weight ratio between the one or more oils and the one or more solid fats may be between 80:20 and 95:5, preferably between 85:15 and 95:5.

In this case, moreover, per 100 g of product the carbohydrates may be less than 30 g, and preferably less than or equal to 25 g.

In this case, moreover, per 100 g of product the total fats may be less than 40 g, and preferably less than or equal to 37.5 g. Suitably, moreover, per 100 g of product the saturated fats may be less than 12 g, and preferably less than or equal to 10 g.

Preferably, the lipid component (A) will not consist of oil only. In this case, indeed, the food cream would be too liquid, therefore the spreadability would be compromised. On the other hand, a lipid component (A) consisting of solid fat only would not have a good spreadability.

In this case, in order to maintain a good consistency and an excellent spreadability of the cream, the one or more oils may be in a quantity that is less than or equal to 30% by weight with respect to the total weight of the food cream, preferably less than or equal to 25% by weight with respect to the total weight of the food cream, and even more preferably less than or equal to 22% by weight with respect to the total weight of the food cream.

The lipid component (A) may may be of either vegetable or animal origin.

The flavour component (B) may be selected from the group consisting of: freeze-dried smoked salmon, semi-finished product of corn with cheese, powder of melted cheese, freeze-dried pecorino romano cheese, freeze-dried cream of tomato, dried oregano, freeze-dried mozzarella, or a mixture of two or more of these.

Preferably, the flavour component (B) may be of a quantity between 5% by weight and 50% by weight, more preferably between 10% by weight and 35% by weight, even more preferably between 15% by weight and 28% by weight.

In this way, it may be possible to characterize the salted spreadable cream from an organoleptic and nutritional point of view.

The filler (C) may be selected from the group consisting of: skimmed milk powderwhole, whole milk powder, whey powder, delactosed whey powder, whey demineralized powder, whey protein powder, milk protein powder, or a mixture of two or more of these.

Preferably, the filler (C) may be of a quantity between 5% by weight and 70% by weight, more preferably between 20% by weight and 55% by weight, even more preferably between 30% by weight and 45% by weight.

The one or more emulsifiers (D) may be one or more lecithins, preferably a sunflower lecithin.

Preferably, the one or more emulsifiers (D) may be present in the food cream in a quantity from 0.25% by weight to 2.5% by weight, and even more preferably from 0.35% by weight to 2% by weight.

Moreover, the one or more supporting ingredients (E), if present, may be selected from the group consisting of: salt, fat-soluble flavours, dyes, preservatives, starches, food additives, or a mixture of two or more of these.

If present, the one or more supporting ingredients (E) may be present in the food cream in a quantity from 0.1% by weight to 5% by weight, preferably from 0.25% by weight to 4% by weight and even more preferably from 0.5% by weight to 3% by weight.

In this way, it will be possible to contribute to the improvement of the organoleptic, nutritional and structural performance of the food cream.

According to a preferred but not exclusive embodiment, the salted spreadable food cream in accordance with the present invention may be consisting:
A) from 20% by weight to 50% by weight of at least one lipid component which includes or is consisting of at least one solid fat;
B) from 10% by weight to 35% by weight of at least one dehydrated and/or dried and/or freeze-dried flavour component;
C) from 20% by weight to 55% by weight of at least one filler consisting of milk or its derivatives;
D) from 0.2% by weight to 3% by weight of at least one emulsifier;
E) from 0% by weight (that is to say not present) to 5% by weight of at least one further supporting ingredient;
wherein the % by weight are related to the total weight of the food cream and the sum of the components from A) to E) is the 100% of the food cream.

According to another preferred but not exclusive embodiment, the salted spreadable food cream in accordance with the present invention may be consisting:
A) from 30% by weight to 40% by weight of at least one lipid component which includes or is consisting of at least one solid fat;
B) from 15% by weight to 28% by weight of at least one dehydrated and/or dried and/or freeze-dried flavour component;
C) from 30% by weight to 45% by weight of at least one filler consisting of milk or its derivatives;
D) from 0.2% by weight to 3% by weight of at least one emulsifier;
E) from 0% by weight (that is to say not present) to 5% by weight of at least one further supporting ingredient;
wherein the % by weight are related to the total weight of the food cream and the sum of the components from A) to E) is the 100% of the food cream.

The food cream may be salted, that is to say perceived by the consumer as such. Salt may be already present in the ingredients or added, for example as fine salt.

In particular, the food cream may have a quantity of salt between 1 g/100 g and 2.5 g/100 g.

Preferably, the quantity of salt may be between 1.3 g/100 g and 2.2 g/100 g.

In a per se known way, the quantity of salt may be evaluated during the calculation of the nutritional values of the food cream and it may correspond to the quantity of salt that is naturally present in the ingredients. On the other hand, the quantity of salt may be evaluated by the method of the per se known titration.

The food cream according to the invention may have a fineness between 10 μm and 100 μm, preferably between 14 μm and 60 μm, more preferably between 15 μm and 45 μm and even more preferably between 16 μm and 30 μm.

The fineness measurement may be done in a per se known way by a Sedigraph or by a grindometer, possibly in accordance with the ISO 1524:2020 standards.

In this way, the food cream will acquire a particular velvety appearance.

Moreover, the food cream may be substantially anhydrous, and have a value of water activity lower than 0.5 measured according to the ISO 18787: 2017 standards.

Such value related to the water activity may ensure the absence of microorganisms proliferation, capable of making the food cream deteriorate.

In this way, it will be possible to give the food cream a shelf life at ambient temperature or substantially around 20° C.-30° C. lasting over time, even after contact between the cream itself and the air, for example once its package has been opened.

Thanks to such characteristics, the food cream according to the invention may reach a shelf life equal to or longer than 12 months from the date of production, or even more in case of modified atmosphere packaging.

Moreover, once the package has been opened, the food cream may have a shelf life of 12 months. Such times are compatible with the standards of the modern food industry.

Suitably, the food cream may be substantially free of added sugars, sweeteners, cocoa and derivatives such as chocolate and dried fruit.

In particular, it may be free of dried fruit such as hazelnuts, almonds, pistachios, peanuts and similar.

Preferably, the food cream may have a carbohydrate content of which sugars being less than or equal to 32% by weight.

Such sugars may be the sugars that are naturally present within the raw material itself.

The food spreadable cream according to the present invention can be prepared by refining the ingredients, for example in a ball mill of a per se known type.

Suitably, the refining process may take place at a working temperature between 30° C. and 55° C., more preferably between 35° C. and 50° C., even more preferably between 40° C. and 45° C.

Furthermore, the refining may take place in an overall working time between 20 minutes and 140 minutes, and preferably between 40 minutes and 120 minutes.

Prior to refining, the solid fat may be melted by melting it at a maximum melting temperature of 50° C., for a working time between 60 minutes and 120 minutes, in order to bring it into liquid or semi-liquid form.

For example, the melting of the solid fat may be done by a per se known melter, or by melting the latter in a steel pot placed on an induction plate.

Alternatively, it may be possible to collect the solid fat already in liquid form, for example from a suitable heated container.

Subsequently, the solid fat in liquid or semi-liquid form together with the oil may be inserted into a ball mill along with the above ingredients B, C), D) and optionally E) for the refining.

Optionally, the lipid component (A) including solid fat and oil may be a pre-made semi-finished product, of a per se known type.

Ingredients B, C), D) and optionally E) may be all inserted in the ball mill and it may be possible to proceed with the temperatures and times described above.

Preferably, however, the refining may take place in two successive steps, first refining the solid fat in liquid or semi-liquid form, the possible oil, and the ingredients B, C) and optionally E) and then, subsequently, by inserting into the ball mill the emulsifier D) and proceeding to a second refining of the assembly until the above-mentioned granulometry.

Even in this case the working temperatures may be those described above. Regarding the working times, the first refining step may take place in 20 minutes-110 minutes, and preferably in 40 minutes-90 minutes, while the second refining step may take place in 35 minutes-85 minutes, and preferably in 45 minutes-75 minutes.

In a preferred but not exclusive embodiment, the ingredients B), C) and optionally D) and E) may be in the form of semi-finished product already mixed in solid form, preferably in powder form. In particular, such semi-finished product may have a residual humidity that is less than or equal to 5%, measured in a per se known way.

Possibly, such semi-finished product may be prepared by mixing the ingredients and optionally by grinding them in a suitable machine, of a per se known type.

Depending on whether the refining takes place in a single step or in two successive steps, the semi-finished product may or may not include the emulsifier D).

After refining, the obtained cream may be filtered through the use of a circular vibrating screen or a vibrating sieve with magnetic filters, equipped with a square mesh filter with a net light of 300-1000 μm, in order to retain any residues of not completely refined ingredients.

The filtered cream may be stocked in different containers depending on the needs. For example, the cream may be stored in thermostated deposits having an internal agitator or inside bucket-type containers of different capacities.

According to another example, the filtered food cream may be pushed, for example through the use of a pump, through pipes in order to be transported to an area of the production chain used for packaging.

What described above will be detailed with reference to the following examples which, in any case, are not intended to limit the scope of protection of the invention.

### EXAMPLES

Several examples of spreadable food creams in accordance with the present invention have been made. For each of these creams the following values have been measured:
the salt quantity in g/100 g of product;
the viscosity in cP by a Brookfield® viscometer;
the granulometry in μm by the Sedigraph method;
the water activity measured according to ISO 18787: 2017 standards.

### Example No. 1—Pizza Flavored Salted Spreadable Cream

A winter variant of a cream (10 kg) was prepared, with the addition of table salt, the presence of two freeze-dried products and two different lipids, a solid fat such as cocoa butter and a liquid oil such as extra virgin olive oil in a composition of 15.0% and 85.0% respectively. The cream in question has the characteristic flavor of tomato and the scent of oregano, with a delicate note of mozzarella. The composition is in the following table.

| | SUPPLIER | INGREDIENT | DESCRIPTION | % |
|---|---|---|---|---|
| B | LYOITALIA | Creamy tomato | freeze-dried | 26.786 |
| | | soup | powder | |
| A | MONINI | extra virgin olive | oil | 28.600 |
| | | oil | | |
| C | REIRE | Whey | powder | 23.681 |
| B | LYOITALIA | Julienne | freeze-dried | 8.066 |
| | | mozzarella | in sticks | |
| A | ICAM | cocoa butter | solid fat | 5.000 |
| C | REIRE | skimmed milk | powder | 6.517 |
| D | Padovana | sunflower lecithin | liquid | 0.700 |
| | Macinazione | | | |
| B | BIO AROMI | oregano | dried | 0.400 |
| E | ITALKALI | salt | fine | 0.250 |

The cream was first prepared by melting the cocoa butter in a melter at a temperature of 40° C., then adding the oil and placing it all in a ball mill with the powders. After about 50 minutes, the lecithin is added and the ball mill is restarted for a further 60 minutes. During refining, the temperature did not exceed 45° C. The characteristics of this cream are:

| | |
|---|---|
| Water activity (Aw): | 0.25 |
| Viscosity (cP): | 39,000 |
| Granulometry (μm): | 18.2 |
| Salt (g/100 g): | 2.1 |

Nutritional values per 100 g of product:

| | | |
|---|---|---|
| Energy value: | 530.7 | Kcal |
| Proteins: | 10.1 | g |
| Carbohydrates: | 37.4 | gr |
| of which sugars | 25.0 | g |
| Fat: | 37.9 | g |
| of which saturated: | 8.7 | g |
| of which monounsaturated: | 11.2 | g |
| of which polyunsaturated: | 14.5 | g |

### Example No. 2—Pecorino Cheese Flavored Salted Spreadable Cream

The summer variant of a cream (10 kg) was prepared, without added salt, with the presence of only one freeze-dried product and two different lipids, a solid fat such as cocoa butter and a liquid oil such as sunflower oil in a composition of 20.5% and 79.5% respectively. The flavor of this cream is typical of pecorino cheese, in the Roman variant. The composition is in the following table.

| | SUPPLIER | INGREDIENT | DESCRIPTION | % |
|---|---|---|---|---|
| C | REIRE | Whey | powder | 38.580 |
| B | LYOITALIA | Pecorino cheese | freeze-dried | 27.000 |
| A | OP CERALI | sunflower seed oil | oil | 20.220 |
| C | REIRE | skimmed milk | powder | 8.500 |
| A | ICAM | cocoa butter | fat | 5.200 |
| D | Padovana Macinazione | sunflower lecithin | liquid | 0.500 |

Similarly to the foregoing, the cream was first prepared by melting the cocoa butter in a melter at a temperature of 40° C., then adding the oil and placing it all in a ball mill with the powders. After about 50 minutes, the lecithin is added and the ball mill is restarted for a further 60 minutes. During refining, the temperature did not exceed 45° C. The characteristics of this cream are:

| | |
|---|---|
| Water activity (Aw): | 0.21 |
| Viscosity (cP): | 41,000 |
| Granulometry (μm): | 21.0 |
| Salt (g/100 g): | 2.2 |

Nutritional values per 100 g of product:

| | | |
|---|---|---|
| Energy value: | 572.6 | Kcal |
| Proteins: | 18.2 | g |
| Carbohydrates: | 33.5 | g |
| of which sugars | 29.6 | g |
| Fat: | 40.7 | g |
| of which saturated: | 16.1 | g |
| of which monounsaturated: | 8.5 | g |
| of which polyunsaturated: | 10.3 | g |

### Example No. 3—Cheese Flavored Salted Spreadable Cream

A cream (10 kg) was prepared without added salt, with the presence of a mixture of powdered melted cheeses, two palm oil-based lipids, and a soy lecithin, the result is a cheese flavored cream, without a precise connotation, since a blend of cheeses is used, in a lower quantity than other recipes. The composition is in the following table.

| | SUPPLIER | INGREDIENT | DESCRIPTION | % |
|---|---|---|---|---|
| A | UNIGRA′ | UNIGRIN C230 | fat | 41.500 |
| C | REIRE | Whey | powder | 38.500 |
| B | LACTOSAN | melted cheese | powder | 10.000 |
| C | REIRE | skimmed milk | powder | 8.500 |
| D | Padovana Macinazione | soy lecithin | liquid | 1.500 |

Similarly to the foregoing, the cream was first prepared by melting the solid fat in a melter at a temperature of 40° C., then placing it in a ball mill with the powders. After about 50 minutes, the lecithin is added and the ball mill is restarted for a further 60 minutes. During refining, the temperature did not exceed 45° C. The characteristics of this cream are:

| | |
|---|---|
| Water activity (Aw): | 0.24 |
| Viscosity (cP): | 37,000 |
| Granulometry (μm): | 19.4 |
| Salt (g/100 g): | 1.3 |

Nutritional values per 100 g of product:

| | | |
|---|---|---|
| Energy value: | 589.4 | Kcal |
| Proteins: | 9.3 | g |
| Carbohydrates: | 38.1 | g |
| of which sugars | 30.4 | g |
| Fat: | 44.5 | g |
| of which saturated: | 14.6 | g |
| of which monounsaturated: | 0.0 | g |
| of which polyunsaturated: | 0.0 | g |

### Example No. 4—Puff Flavored Salted Spreadable Cream

A cream (10 kg) was prepared without added salt, with the presence of a purchased semi-finished product, in detail it is a corn with cheese snack, available on the market under the trade name of “Puff” from the company CRIK CROK, two palm oil-based lipids. Furthermore, the recipe is by its very nature gluten-free. The composition is in the following table.

| | SUPPLIER | INGREDIENT | DESCRIPTION | % |
|---|---|---|---|---|
| B | CRIK CROK | Puff | Corn with cheese | 33.500 |
| | | | semi-finished product | |
| A | UNIGRA′ | UNIGRIN C230 | fat | 28.800 |
| C | REIRE | Whey | powder | 27.500 |
| C | REIRE | skimmed milk | powder | 6.000 |
| A | UNIGRA′ | UNIGRAL F936 | fat | 3.200 |
| D | Padovana | sunflower lecithin | liquid | 1.000 |
| | Macinazione | | | |

Similarly to the foregoing, the cream was first prepared by melting the solid fat in a melter at a temperature of 40° C., then placing it in a ball mill with the powders and the corn semi-finished product. After about 50 minutes, the lecithin is added and the ball mill is restarted for a further 60 minutes. During refining, the temperature did not exceed 45° C. The characteristics of this cream are:

| | |
|---|---|
| Water activity (Aw): | 0.25 |
| Viscosity (cP): | 32,000 |
| Granulometry (μm): | 19.9 |
| Salt (g/100 g): | 1.4 |

Nutritional values per 100 g of product:

| | | |
|---|---|---|
| Energy value: | 577.9 | Kcal |
| Proteins: | 7.6 | g |
| Carbohydrates: | 44.1 | g |
| of which sugars | 24.7 | g |
| Fat: | 41.2 | g |
| of which saturated: | 3.9 | g |
| of which monounsaturated: | 0.0 | g |
| of which polyunsaturated: | 0.0 | g |

### Example No. 5—Smoked Salmon Flavored Salted Spreadable Cream

A cream (10 kg) was prepared with the addition of salt, the presence of a freeze-dried product based on a fish product such as salmon in the smoked version, a palm oil-based lipid and coconut, the recipe being also gluten free. The composition is in the following table.

| | SUPPLIER | INGREDIENT | DESCRIPTION | % |
|---|---|---|---|---|
| C | REIRE | Whey | powder | 38.500 |
| A | UNIGRA′ | UNIGRIN C230 | fat | 37.000 |
| B | LYOITALIA | smoked salmon | freeze-dried | 15.000 |
| C | REIRE | skimmed milk | powder | 8.350 |
| D | Padovana Macinazione | sunflower lecithin | liquid | 1.000 |
| E | ITALKALI | salt | fine | 0.150 |

The cream was first prepared by melting the solid fat in a melter at a temperature of 40° C., then placing it in a ball mill with the powders. After about 50 minutes, the lecithin is added and the ball mill is restarted for a further 60 minutes. During refining, the temperature did not exceed 45° C. The characteristics of this cream are:

| | |
|---|---|
| Water activity (Aw): | 0.21 |
| Viscosity (cP): | 35,000 |
| Granulometry (μm): | 20.5 |
| Salt (g/100 g): | 1.6 |

Nutritional values per 100 g of product:

| | | |
|---|---|---|
| Energy value: | 596.1 | Kcal |
| Proteins: | 15.0 | g |
| Carbohydrates: | 33.7 | g |
| of which sugars | 31.1 | g |
| Fat: | 44.6 | g |
| of which saturated: | 13.4 | g |
| of which monounsaturated: | 0.0 | g |
| of which polyunsaturated: | 0.0 | g |

### Example No. 6—Parmigiano Reggiano Cheese Flavored Protein Salted Spreadable Cream

The high protein variant of a cream (10 kg) was prepared, with the addition of common salt, with the presence of only one freeze-dried product and two different lipids, one solid fat such as cocoa butter and one liquid oil such as sunflower oil in a weight ratio of 11:89, of milk derivatives proteins of animal origin, of chicory fiber (inulin). The taste of this cream is typical of Parmigiano Reggiano cheese. The composition is in the following table.

| | SUPPLIER | INGREDIENT | DESCRIPTION | % |
|---|---|---|---|---|
| C | REIRE | Whey concentrated | powder | 34.000 |
| | | proteins | | |
| A | OP CEREALI | High oleic sunflower | oil | 24.000 |
| | | oil | | |
| B | LYO EUROPA | Parmigiano reggiano | freeze-dried | 21.000 |
| B | REIRE | Inulin | powder | 7.000 |
| C | REIRE | skimmed milk | powder | 6.500 |
| C | REIRE | Whey | powder | 3.000 |
| A | ICAM | Cocoa butter | solid fat | 3.000 |
| D | PADOVANA | Sunflower lecithin | emulsifier | 1.200 |
| | MACINAZIONE | | | |
| E | ITALKALI | Salt | fine | 0.300 |

The cream was first prepared by melting the cocoa butter in a melter at a temperature of 40° C., then adding the oil and placing it all in a ball mill with the powders. After about 50 minutes, the lecithin is added and the ball mill is restarted for a further 60 minutes. During refining, the temperature did not exceed 45° C. The characteristics of this cream are:

| | |
|---|---|
| Water activity (Aw): | 0.30 |
| Viscosity (cP): | 37,000 |
| Granulometry (μm): | 22 |
| Salt (g/100 g): | 0.8 |

Nutritional values per 100 g of product:

| | | |
|---|---|---|
| Energy value: | 548.8 | Kcal |
| Proteins: | 37.8 | g |
| Carbohydrates: | 19.6 | g |
| of which sugars | 6.5 | gr |
| Fat: | 14.5 | g |
| of which saturated: | 11.2 | g |
| of which monounsaturated: | 14.5 | g |
| of which polyunsaturated: | 14.5 | g |

### Example No. 7—Pesto Genovese Flavored Protein Salted Spreadable Cream

The high protein variant of a cream (10 kg) was prepared, with the addition of common salt, the presence of only one freeze-dried product and two different lipids, one solid fat such as cocoa butter and one liquid oil such as sunflower oil in a weight ratio of 11.0:89.0, of milk derivatives proteins of animal origin, chicory fiber (inulin), of pre-cooked semolina in the form of flour. The cream in question has the characteristic flavor of pesto genovese, with a predominant note of basil, a good taste of pecorino cheese and a final note of toasted pine nuts. The composition is in the following table.

| | SUPPLIER | INGREDIENT | DESCRIPTION | % |
|---|---|---|---|---|
| C | REIRE | Whey concentrated | powder | 26.500 |
| | | proteins | | |
| A | OP CEREALI | High oleic sunflower | oil | 25.800 |
| | | oil | | |
| B | LYO EUROPA | Pesto genovese | freeze-dried | 19.000 |
| B | REIRE | Inulin | powder | 7.500 |
| C | PADOVANA | pre-cooked semolinas | flour | 6.950 |
| | MACINAZIONE | | | |
| C | REIRE | Low-fat milk | powder | 6.500 |
| A | ICAM | Cocoa butter | solid fat | 3.200 |
| C | REIRE | Whey | powder | 2.800 |
| D | PADOVANA | Sunflower lecithin | emulsifier | 1.200 |
| | MACINAZIONE | | | |
| E | ITALKALI | Salt | fine | 0.550 |

The cream was first prepared by melting the cocoa butter in a melter at a temperature of 40° C., then adding the oil and placing it all in a ball mill with the powders. After about 50 minutes, the lecithin is added and the ball mill is restarted for a further 60 minutes. During refining, the temperature did not exceed 45° C. The characteristics of this cream are:

| | |
|---|---|
| Water activity (Aw): | 0.34 |
| viscosity (cP): | 42,000 |
| Granulometry (μm): | 21 |
| Salt (g/100 g): | 1.7 |

Nutritional values per 100 g of product:

| | | |
|---|---|---|
| Energy value: | 536.0 | Kcal |
| Proteins: | 28.0 | g |
| Carbohydrates: | 27.7 | gr |
| of which sugars | 6.5 | g |
| Fat: | 34.8 | g |
| of which saturated: | 8.3 | g |
| of which monounsaturated: | 0.0 | g |
| of which polyunsaturated: | 0.0 | g |

### Example No. 8—Pizza Flavored Protein Salted Spreadable Cream

The High Protein Variant of a Cream (10 kg) was Prepared, with the Addition of Common salt, with the presence of two freeze-dried products and two different lipids, one solid fat such as cocoa butter and one liquid oil such as sunflower oil in a weight ratio of 18:82, of milk derivatives proteins of animal origin, of from chicory fiber (inulin). The cream in question has the characteristic flavor of tomato and the scent of oregano, with a delicate note of mozzarella. The composition is in the following table.

| | SUPPLIER | INGREDIENT | DESCRIPTION | % |
|---|---|---|---|---|
| C | REIRE | Whey concentrated | powder | 37.000 |
| | | proteins | | |
| A | OP CEREALI | High oleic sunflower | oil | 27.300 |
| | | oil | | |
| B | LYO EUROPA | Tomato | freeze-dried | 13.000 |
| B | REIRE | Inulin | powder | 7.000 |
| C | ICAM | Cocoa butter | solid fat | 6.000 |
| B | LYO EUROPA | Mozzarella | freeze-dried | 5.000 |
| C | REIRE | Whey | powder | 3.000 |
| D | PADOVANA | Sunflower lecithin | emulsifier | 1.200 |
| | MACINAZIONE | | | |
| E | ITALKALI | Salt | fine | 0.300 |
| E | BIO AROMI | Dried oregano | dried | 0.200 |

The cream was first prepared by melting the cocoa butter in a melter at a temperature of 40° C., then adding the oil and placing it all in a ball mill with the powders. After about 50 minutes, the lecithin is added and the ball mill is restarted for a further 60 minutes. During refining, the temperature did not exceed 45° C. The characteristics of this cream are:

| | |
|---|---|
| Water activity (Aw): | 0.32 |
| viscosity (cP): | 25,000 |
| Granulometry (μm): | 21 |
| Salt (g/100 g): | 1.2 |

Nutritional values per 100 g of product:

| | | |
|---|---|---|
| Energy value: | 563.7 | Kcal |
| Proteins: | 30.7 | g |
| Carbohydrates: | 25.0 | g |
| of which sugars | 6.2 | g |
| Fat: | 36.5 | g |
| of which saturated: | 8.4 | g |
| of which monounsaturated: | 0.0 | g |
| of which polyunsaturated: | 0.0 | g |

The invention claimed is:

1.-35. (canceled)

36. A method for preparing a food cream that is salty and spreadable, the food cream consisting of:
(A) 20% by weight to 50% by weight of at least one lipid component consisting of at least one solid fat and at least one oil;
(B) 5% by weight to 50% by weight of at least one dehydrated, dried, and/or freeze-dried flavor component;
(C) 20% by weight to 55% by weight of at least one filler consisting of powdered milk or its derivatives;
(D) 0.2% by weight to 3% by weight of at least one emulsifier; and
(E) 0% by weight to 5% by weight of at least one additional supporting ingredient;
wherein the food cream has a quantity of salt between 1 g and 2.5 g per 100 g of the food cream;
wherein the food cream has a viscosity as measured in accordance with ISO 2555:2018 between 11,000 cP and 65,000 cP;
wherein the food cream has a fineness as measured in accordance with ISO 1524:2020 between 10 μm and 100 μm;
wherein the food cream has a water activity value as measured in accordance with ISO 18787: 2017 lower than 0.5;
wherein the at least one oil is less than or equal to 30% by weight with respect to a total weight of the food cream; and
wherein the food cream is substantially free of cocoa and derivatives thereof and dried fruit;
the method comprising:
providing ingredients from (A) to (D) and optionally (E); and
refining the ingredients from (A) to (D) and optionally (E) at a first predetermined working temperature for a first predetermined working time;
wherein the first predetermined working temperature is in a range from 35° C. to 50° C., the first predetermined working time being between 20 minutes and 140 minutes.

37. The method according to claim 36, wherein the first predetermined working temperature is lower than or equal to 45° C.

38. The method according to claim 36, wherein providing the ingredients further comprises:
providing the at least one lipid component (A) comprises providing the at least one lipid component having at least one solid fat melted to be in liquid or semi-liquid form; and
providing a semi-finished product consisting of the ingredients (B) and (C), and optionally (D) and (E), in powder form, in which a residual humidity of the semi-finished product is equal to or less than 5%.

39. The method according to claim 38, wherein the semi-finished product is free of the at least one emulsifier (D), refining the ingredients comprising:
first refining the ingredients (A), (B), (C) and optionally (E) at a second predetermined working temperature for a second predetermined working time;
adding the at least one emulsifier (D);
second refining of the ingredients (A), (B), (C), (D) and optionally (E) at a third predetermined working temperature for a third predetermined working time; and
wherein the second and the third predetermined working temperatures are between 30° C. and 55° C., the second predetermined working time being 20 minutes to 110 minutes, and the third predetermined working time being 35 minutes to 85 minutes.

40. The method according to claim 39, wherein the second and the third predetermined working temperature are lower than or equal to 45° C.

41. The method according to claim 38, wherein providing the at least one lipid component (A) in liquid or semi-liquid form comprises melting the at least one lipid component (A) at a maximum predetermined melting temperature for a predetermined melting time; and wherein the maximum predetermined melting temperature is 50° C., the predetermined melting time being between 60 minutes and 120 minutes.

42. The method according to claim 36, wherein the at least one lipid component (A) is in a quantity between 30% by weight to 40% by weight.

43. The method according to claim 36, wherein the viscosity is between 20,000 cP and 55,000 cP.

44. The method according to claim 36, wherein in the at least one lipid component (A) a weight ratio between the at least one oil and the at least one solid fat is between 60:40 and 95:5.

45. The method according to claim 36, wherein the at least one oil is in a quantity that is less than or equal to 25% by weight with respect to the total weight of the food cream.

46. The method according to claim 44, wherein the at least one solid fat is selected from the group consisting of: cocoa butter, palm butter, coconut fat, cow butter, karité butter, illipe butter, or a mixture of two or more thereof.

47. The method according to claim 44, wherein the at least one oil is selected from the group consisting of: sunflower oil, olive oil, extra virgin olive oil, rapeseed oil, rice oil, corn oil, linseed oil, sesame seed oil, peanut oil, or a mixture of two or more thereof.

48. The method according to claim 36, wherein the at least one flavor component is a freeze-dried flavor component.

49. The method according to claim 36, wherein the at least one flavor component is selected from the group consisting of: freeze-dried smoked salmon, a semi-finished product of corn with cheese, a powder of melted cheese, freeze-dried pecorino romano cheese, freeze-dried cream of tomato, dried oregano, freeze-dried mozzarella, or a mixture of two or more thereof.

50. The method according to claim 36, wherein the at least one filler is selected from the group consisting of: skimmed milk powder, whole milk powder, whey powder, delactosed whey powder, whey demineralized powder, whey protein powder, milk protein powder, or a mixture of two or more thereof.
